(19) United States
(12) Patent Application Publication
(10) Pub. No.: US 2008/0003476 A1
(43) Pub. Date: Jan. 3, 2008

(54) Chemical additives for the suppression of catalyst degradation in fuel cells

(76) Inventor: Anil V. Virkar, Salt Lake City, UT (US)

Correspondence Address: THORPE NORTH & WESTERN, LLP., 8180 SOUTH 700 EAST, SUITE 350, SANDY, UT, 84070, US

(21) Appl. No.: 11/818,213

(22) Filed: Jun. 12, 2007

Related U.S. Application Data
(60) Provisional application No. 60/813,164, filed on Jun. 12, 2006.

(51) Int. Cl. H01M 8/10

(52) U.S. Cl. 429/30; 429/33

(57) ABSTRACT

The present invention is drawn to chemical additives for use in extending the lifespan and efficiency of fuels cells such as proton exchange membrane fuel cells (PEMFC). In particular, additives can be added to the electrolyte solution of a fuel cell sufficient to reduce the concentration of and/or inhibit formation of precious metal ions in solution, e.g. platinum ions.

### RELATED APPLICATIONS

This application claims the benefit of U.S. Provisional Patent Application Ser. No. 60/813,164, filed Jun. 12, 2006, which is incorporated herein by reference.

### FIELD OF THE INVENTION

The present invention relates generally to fuel cells, and in particular electrolyte fuel cells. More particularly, the present invention relates to additive-containing fuel cell electrolyte solutions and their use in stabilizing fuel cell catalysts against degradation.

### BACKGROUND OF THE INVENTION

Proton exchange membrane fuel cells (PEMFC) show great promise as energy sources of the future. However, these fuel cells are not without their drawbacks. PEMFCs use precious metal catalysts to facilitate the necessary reactions which can be very costly. To be effective, it is important that the catalyst particle size be in the low nanometer size range (3 to 6 nm), with the corresponding specific surface area on the order of 50 m 2/g or greater. However, the catalyst particles of PEMFC regularly exhibit growth during operation of the PEMFC. This particle growth causes a reduction in the efficiency and effectiveness of the catalyst effectively degrading the catalyst and rendering the fuel cell ineffective. Such catalyst degradation is a critical and costly factor which currently inhibits the greater commercialization of proton exchange membrane fuel cells. Most approaches focus on modification of the catalyst compositions and/or properties. As such a need exists to reduce or inhibit the degradation of the catalysts in PEMFCs.

### SUMMARY OF THE INVENTION

The present invention is drawn to methods and compositions for stabilizing catalysts in fuel cells. In particular, the present invention provides a fuel cell electrolyte solution which includes an additive. The additive, when added to a proton exchange membrane fuel cell, lowers precious metal ion concentration and/or inhibits formation of precious metal ions. The precious metal ions generally correspond to metals used on the catalysts of the proton exchange membrane fuel cell.

In another embodiment, a method of suppressing catalyst degradation in proton exchange membrane fuel cells is provided. The method includes providing an additive in an amount sufficient to reduce precious metal ion concentration and/or inhibit formation of precious metal ions from the catalyst of the proton exchange membrane fuel cell.

In another embodiment, a fuel cell can comprise a proton exchange membrane impregnated with the electrolyte solution, an anode, and a cathode. The electrolyte solution can include an additive which lowers precious metal ion concentration and/or inhibits formation of precious metal ions. The anode and the cathode can be operatively associated with the proton exchange membrane.

The additive component of the present invention can be water soluble and generally is substantially or completely free of the precious metal used on the catalyst of the proton exchange membrane fuel cell. In one embodiment the additive can include a chloride, an iodide, a bromide, a nitrate, a sulfate, a nitrite, a sulfite, a chlorate, or combinations thereof. In another embodiment the additive can include finely divided silver particles. In yet another more specific embodiment the additive can include, but is not limited to, NH₄I, NH₄C₁, NH₄Br, finely divided silver particles, or mixtures thereof. As a general guideline, the additive can be present from about 0.001 vol % to about 10 vol % of the electrolyte solution. However, volumes outside this range may also be suitable depending on the specific additive and catalyst system.

There are a variety of precious metals which can be used in the catalysts of proton exchange membrane fuel cells. In one embodiment the precious metal of the fuel cell catalyst can be platinum, palladium, rhodium, iridium, gold, silver, alloys thereof, or alloys thereof with other metals. In another embodiment the precious metal is platinum or alloys thereof.

### BRIEF DESCRIPTION OF THE DRAWINGS

FIG. 1 is a schematic illustration showing a mechanism of particle growth by dissolution/precipitation. The chemical potential of smaller particles is higher than that of larger particles. Thus, if some solubility exists in the liquid, particle growth (coarsening) can occur by dissolution-precipitation (Ostwald ripening).

FIG. 2 is a schematic illustration showing the establishment of equilibrium conditions, under which particle growth is shut down in accordance with an embodiment of the present invention. Under this condition, the electrochemical potential of the cation (e.g. Pt²⁺) is equilibrated. Thus, with Pt as the metal, assuming Pt ion exists as Pt²⁺, electrochemical potentials of Pt²⁺ in the smaller and larger particles become identical. In this scenario, the only way particle growth can occur is to provide a path for electrons from the smaller particle to the larger particle.

FIG. 3 is schematic illustration showing the transport of Pt from a smaller particle to a larger particle by coupled transport of Pt²⁺ through the medium and transport of electrons through the carbon support. The same transport mechanism can be operative with Pt⁴⁺, except that four electrons are transported per one Pt⁴⁺ ion.

FIGS. 4a and 4b show transmission electron micrographs of E-TEK Pt—C catalysts. FIG. 4a, as-received, shows the Pt particle size is about 3 to 4 nm. FIG. 4b, after 3 hours in a dilute PtCl₄ (a couple of drops of 0.01 M solution in water)+HNO₃ (pH=3) solution, showing the profound effect of platinum ions in solution on growth kinetics, and provides support to the present invention.

FIGS. 5a and 5b show a graphical representation of the platinum particle size distribution in E-TEK (20% Pt—C) catalyst. FIG. 5a shows the as-received catalyst having average Pt particle size of about 3.5 nm. FIG. 5b shows particle size distribution after 3 hours in a dilute PtCl₄ (a couple of drops of 0.01 M solution in water)+HNO₃ (pH=3) solution with an average Pt particle size of about 6.5 nm.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a previous metal” includes one or more of such precious metals, reference to “the additive” includes reference to one or more of such additives, and reference to “providing” includes reference to one or more of such steps.

Definitions

In describing and claiming the present invention, the following terminology will be used in accordance with the definitions set forth below.

As used herein, “electrolyte solution” refers to a liquid used in fuel cells which generally acts as a medium across which ions can be transported to either a cathode and/or anode. Electrolyte solutions can be those used in PEM fuel cells to wet an electrolytic membrane as well as other fuel cells such as, but not limited to, alkaline and phosphoric acid fuel cells.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. For example, palladium and iridium are listed in a common list of catalyst metals. However, these two materials can exhibit dramatically different catalytic activity and rates of Otswald ripening under the same conditions.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 μm to about 5 μm” should be interpreted to include not only the explicitly recited values of about 1 μm and about 5 μm, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described. In accordance with this principle, the term “about” expressly includes “exactly” unless otherwise indicated. Any such “exact” values would not be limited in terms of available equivalents merely based on the above flexible interpretation.

### EMBODIMENTS OF THE INVENTION

In proton exchange membrane fuel cells (PEMFC), state-of-the-art anode and cathode catalysts contain precious metals, typically platinum (Pt). The catalyst may be pure Pt or alloys of Pt with other precious metals. The catalysts may also comprise, or consist essentially, of other precious or non-precious metals including palladium, rhodium, iridium, gold, silver, alloys thereof, or alloys thereof with other metals. In some embodiments, the catalyst particle size can be in the low nanometer size range (3 to 6 μm), with a corresponding specific surface area on the order of 50 m²/g or greater. Broadly, catalyst particles can have a size from about 1 nm to about 200 nm. Similarly, workable catalyst particles can typically have a specific surface area range from about 5 m²/g to about 200 m²/g. In view of the high cost of platinum, for automotive applications Pt loading per electrode is often from about 0.2 mg/cm² to about 0.4 mg/cm². By using very fine (2 to 3 nm) catalyst particle size, required performance targets at such low loading can be achieved with careful processing.

During conventional PEMFC operation, catalyst particles exhibit growth. This growth occurs when smaller particles dissolve in the prevailing medium and precipitate on the larger particles. This phenomenon is known as coarsening, Ostwald ripening, or particle growth by dissolution-precipitation. Experimental work has shown that in a mere 1,000 hours, the average particle size can readily increase from about 2 to 3 nm to well over 15 nm. As the catalytic activity is proportional to the specific surface area (or inversely proportional to the catalyst particle size), particle growth means a drastic loss in catalytic activity, and thus in performance. A smaller particle size results in faster growth kinetics, i.e. faster degradation kinetics. As a point of comparison for the above example of degradation times, the typical desired service life for automotive applications is about 5,500 hours, while that for stationary applications is about 40,000 hours. Thus, using embodiments of the present invention can extend useful service life well into the above ranges and beyond. In conventional PEMFCs average catalyst particle sizes can experience up to about 500% growth in diameter over 5,500 hours and up to about 1000% growth over about 40,000 hours. In contrast, PEMFCs which incorporate the present invention can experience catalyst particle growth of from 0% to about 200%, preferably 0% to about 50%, over 5,500 hours, and 0% to about 500%, preferably 0% to about 100%, over about 40,000 hours. Although illustrative of the growth suppression of the present invention, these ranges of growth can vary significantly depending on the particular materials and operating conditions.

The electrolyte solution can depend on the particular choice of catalyst, membrane or insulating materials, and fuel cell configuration. In one embodiment, the electrolyte solution can be aqueous. Non-limiting examples of suitable electrolyte solutions can include polymer electrolyte, potassium hydroxide, phosphoric acid, and the like. Electrolyte solutions can generally have a high concentration of the electrolyte, e.g. from about 70-100%. Although the present invention is particularly effective for use with proton exchange membrane fuel cells, the inventive principle can be readily and effectively applied in other types of fuel cells including but not limited to phosphoric acid fuel cells (FC), direct methanol FCs, and alkaline FCs.

Dissolution-precipitation can occur in solid-solid systems, liquid-solid systems, vapor-liquid as well as in vapor-solid systems. However, the mechanistic details can vary substantially from system to system. For example, if the system is metallic (particles and the medium), atomic diffusion through the medium is a necessary step for growth. If the medium is a liquid, such as an ionic solution (or a melt), and the particles exhibit ionic bonding, transport of both positive ions (cations) and negative ions (anions) can occur, which in turn can lead to dissolution-precipitation. The PEMFC system, in one respect is different from such systems because the particles are metallic but the medium is generally an aqueous solution and/or an ionomer (Nafion). Solubility of metallic materials, as metals, in aqueous media is generally negligible. However, solubility of salts (ionic form) can be substantial. This means, low solubility of metals in aqueous media (as metals) also means negligible concentration of electrons in aqueous media. The implication is that dissolution—precipitation of metallic particles should not occur to a measurable extent. However, the platinum catalyst growth does indeed occur in proton exchange membrane fuel cells (PEMFC). The reasons for this growth in PEMFC are described in what follows, based on a mechanism proposed here, which also forms the basis of the invention which teaches how to suppress this growth.

Mechanism of Platinum Catalyst Particle Growth in PEMFCS

Particles of a Material Dispersed in a Liquid in which the Material has Some Solubility:

First, consider two particles of differing radii, rₒ and r₁ such that r₁>rₒ, wherein the material has some solubility in the liquid. The solution is saturated so that no more material can dissolve into it, without precipitating somewhere else. The chemical potential of a particle of a radius r is given by

$$μ ( r ) = μ ( ∞ ) + \frac{2 γ {V}_{m}}{r} \qquad ( 1 )$$

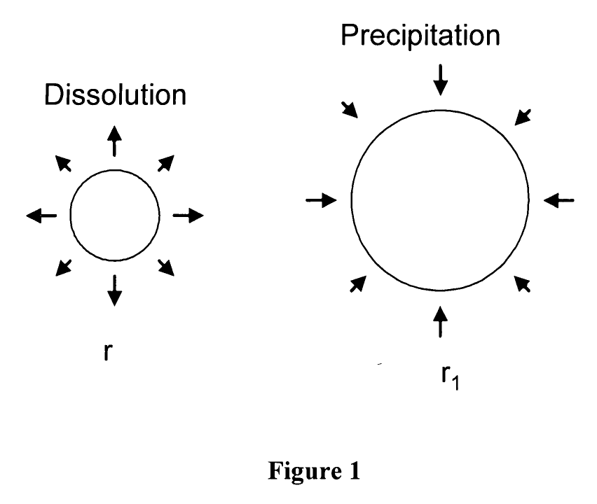

Thus, μ(rₒ)>μ(r₁) since rₒ<r₁. In equation (1), μ(∞) is the chemical potential of a large particle (bulk, or for radius approaching infinity), Vₘ is the molar volume, and r is the interfacial energy. FIG. 1 shows a schematic illustrating that smaller particles can dissolve and deposit on larger particles which effectively causes particle growth by a dissolution—precipitation mechanism.

Now consider that the material is a metal, the liquid is an aqueous solution. In such a case, the material is generally expected to exhibit negligible solubility, for example platinum dispersed in an aqueous solution. Since the solubility of Pt(0) in aqueous liquids is expected to be negligible, it may be assumed that transport of Pt(0) from a smaller particle to a larger particle can be kinetically hindered. In principle, transport of Pt in a liquid as a charged species (ion) can occur. However, as the electron concentration is negligible their transport is hindered. In such a case, the smaller particles will be negatively charged and the larger particles will be positively charged, which will shut down further transport as the electrochemical potential of the charged particles equilibrates. Assuming that all platinum ions exist in a+2 state, the electrochemical potential of the platinum ions (Pt²⁺) in a catalyst particle of radius r, {tilde under (μ)}_{Pt}_{²⁺} (r), can be expressed by

$${\tilde{μ}}_{{Pt}^{2 +}} ( r ) = {μ}_{P {t}^{2 +}} ( ∞ ) + \frac{2 γ {V}_{m}^{Pt}}{r} + 2 F ϕ ( r ) \qquad ( 2 )$$

where, μ_{Pt}_{²⁺} (∞) is the chemical potential of Pt²⁺ ions corresponding to a flat surface (bulk), φ(r) is the electrostatic potential at the surface of a particle of radius r (and also inside), Vₘ^{Pt} is the molar volume of platinum, and F is the Faraday constant. The above describes the electrochemical potential of Pt²⁺ in a metallic Pt particle of radius r. Since platinum is in a metallic state, it is understood that local equilibrium implies the reaction Pt(0)→Pt²⁺+2e (assuming divalent for the sake of discussion) is in equilibrium, which gives
μ_{Pt}(r)={tilde under (μ)}_{Pt}_{²⁺}(r)+2{tilde under (μ)}ₑ(r) (3)
where {tilde under (μ)}ₑ(r) is the electrochemical potential of electrons in a platinum particle of size r given by
{tilde under (μ)}ₑ(r)=μₑ−Fφ(r) (4)
where μₑ is the chemical potential of electrons in platinum (Fermi level).

The further transport of Pt from a smaller particle to a larger particle will be shut down as soon as the electrochemical potential of Pt²⁺ equilibrates, given by

$$\begin{matrix}{\tilde{μ}}_{{Pt}^{2 +}} ( {r}_{o} ) = {μ}_{{Pt}^{2 +}} ( ∞ ) + \frac{2 γ {V}_{m}^{Pt}}{{r}_{o}} + 2 F ϕ ( {r}_{o} ) \\ = {μ}_{{Pt}^{2 +}} ( ∞ ) + \frac{2 γ {V}_{m}^{Pt}}{{r}_{1}} + 2 F ϕ ( {r}_{1} ) \\ = {\tilde{μ}}_{{Pt}^{2 +}} ( {r}_{1} )\end{matrix} \qquad ( 5 )$$

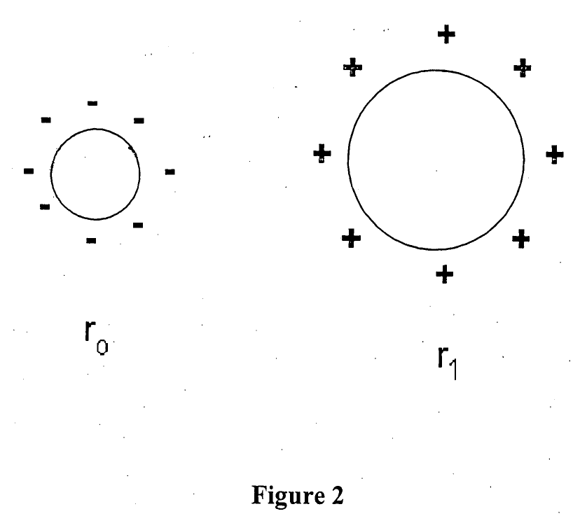

Thus, the particle growth of Pt will not occur as long as the solubility of Pt(0) is negligible. This is shown schematically in FIG. 2 under equilibrium conditions.

If the predominant ionic species present of platinum ion is not Pt²⁺ but rather Pt⁴⁺, the above equation (5) becomes

$$\begin{matrix}{\tilde{μ}}_{{Pt}^{4 +}} ( {r}_{o} ) = {μ}_{{Pt}^{4 +}} ( ∞ ) + \frac{2 γ {V}_{m}^{Pt}}{{r}_{o}} + 4 F ϕ ( {r}_{o} ) \\ = {μ}_{{Pt}^{4 +}} ( ∞ ) + \frac{2 γ {V}_{m}^{Pt}}{{r}_{1}} + 4 F ϕ ( {r}_{1} ) \\ = {\tilde{μ}}_{{Pt}^{4 +}} ( {r}_{1} )\end{matrix} \qquad ( 6 )$$

although the overall logic remains unchanged.

In both of the cases (Pt²⁺ and Pt⁴⁺) considered above, it is clear that φ(r₁)>φ(rₒ). This means, we must have {tilde under (μ)}ₑ (rₒ)>{tilde under (μ)}ₑ(r₁). In other words, there is a thermodynamic driving force for transporting electrons from the smaller particle to the larger particle. However, in the absence of an electronic conducting path, there is no path for the electrons.

For this reason, it would be anticipated that very little particle growth might occur. The preceding discussion suggests that Pt particle growth should not occur to a significant extent. However, significant platinum particle growth does indeed occur in PEMFC. The reasons for this growth are described in what follows and illustrate various mechanisms of the present invention. An important point to note is that in PEMFC catalyst particles (Pt) are typically in contact with supporting carbon black, in which one of the functions of the carbon support is to provide a path for the transport of electrons in and out. That is, in PEMFC, platinum particles are electrically in contact with each other through the supporting carbon black, which can readily transport electrons. In accordance with the present invention, the presence of supporting carbon black is a significant reason that platinum particle growth does occur in PEMFC. This previously unrecognized growth mechanism is described in what follows to provide background for operation of the present invention.

Mechanism of Pt Catalyst Particle Growth in PEMFC:

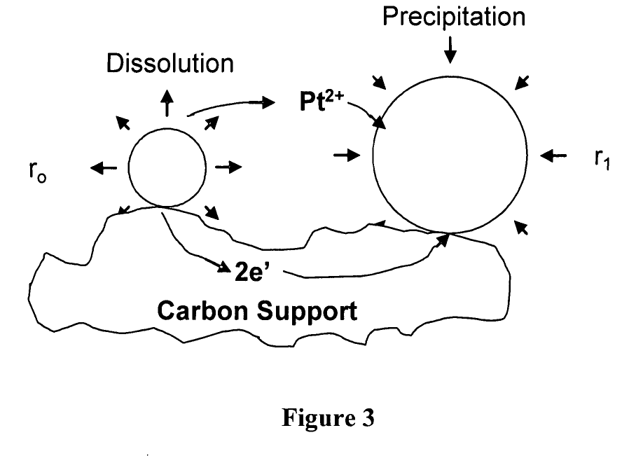

FIG. 3 shows a schematic of the proposed mechanism of particle growth by the transport of platinum ions through the liquid and that of electrons through the carbon support. Transport of electrons through carbon support is rapid and thus not rate limiting. Diffusion coefficients of many of the ionic species through liquids is generally in the range of 10⁻⁶ to 10⁻⁵ cm²/s over the temperature range of interest, which is also very high. However, the transport kinetics is a function of the product of diffusivity and concentration. Thus, the main factor that will dictate transport (and particle growth) will be the solubility of the ionic species (Pt²⁺ and/or Pt⁴⁺) in the liquid, when an electronic shunt (through carbon support) is available. This suggests that Pt growth in PEMFC is expected due in part to the presence of carbon.

Suppression of Particle Growth:

In PEMFC, the role of the carbon support is to carry electronic current in and out in the electrocatalysis process, and is vital to the very operation of the device. Thus, it is imperative that carbon (or some other stable and inert electronic conducting material) must be present. An example of a preferred situation involves an intimate mixing of the carbon support powder and catalyst particles such that: (a) the carbon particles form a contiguous network to provide an electronic path, while maintaining sufficient porosity; (b) the catalyst particles are electrically connected to the carbon support that is in physical contact with the carbon support; and, (c) some amount of the electrolyte (e.g. Nafion) is also present in the mix. One method of suppressing the kinetics of particle growth is to minimize the concentration of platinum ions in solution. In order to minimize growth, the concentration of platinum ions in solution prevailing in the electrodes must be minimized to as low a level as possible. Discussion of how to minimize platinum ion concentration is set forth below. Such discussion provides for the design of key experiments to test the hypothesis, and design methods for suppressing particle growth kinetics and suppressing catalyst degradation. This is first discussed with PtCl₂ as the salt.

PtCl₂ is only slightly soluble in water. Its solubility product may be given as follows;

PtCl₂ (solid)→PtCl₂ (dissolved in water, saturated)→Pt²⁺+2Cl⁻ (in solution)

The solubility product is given by
Kₛ=[Pt²⁺ [symbol] Cl⁻]² (7)
If the law of mass action is assumed, then Kₛ is also assumed to be the equilibrium constant (Debye-Huckel interactions ignored). The platinum ion concentration in solution is thus given by

$$[ {Pt}^{2 +} ] = \frac{{K}_{s}}{{[ {Cl}^{-} ]}^{2}} \qquad ( 8 )$$

If the only salt present is PtCl₂, then the electroneutrality requirement gives
└Cl⁻┘=1└Pt²⁺┘ (9)
and then

$$\begin{matrix}[ {Pt}^{2 +} ] = {( \frac{{K}_{s}}{4} )}^{1 / 3} & ( 10 ) \\ and & \\ [ {Cl}^{-} ] = 2 {( \frac{{K}_{s}}{4} )}^{1 / 3} & ( 11 )\end{matrix}$$

Now suppose one additionally introduces another chloride, for example NH₄Cl at a concentration of C. If you assume that the net concentration of Cl⁻ due to NH₄Cl is much greater than that due to the dissolution of PtCl₂, it can be said that

$$C >> 2 {( \frac{{K}_{s}}{4} )}^{1 / 3} .$$

Therefore, the Pt²⁺ concentration can be expressed by

$$[ {Pt}^{2 +} ] = \frac{{K}_{s}}{{C}^{2}} << {( \frac{{K}_{s}}{4} )}^{1 / 3} \qquad ( 12 )$$

Since the rate of particle growth is proportional to the [Pt²⁺], the preceding suggests that the kinetics of particle growth in an aqueous, saturated solution of PtCl₂ will be considerably faster than in an aqueous saturated solution of PtCl₂ which also contains NH₄Cl. That is, the kinetics of coarsening will be greatly influenced by the presence of other species which affect the solubility of Pt²⁺ as ions.

The preceding assumes that the only ionic species of platinum present is Pt²⁺. However, it is known that PtCl₄ is highly water soluble. The above scheme is expected to be effective in suppressing particle growth, albeit to a smaller degree if significant concentration of Pt⁴⁺ is present in the presence of chloride ions. For the above scheme to more be effective, it is preferred that both Pt²⁺ and Pt⁴⁺ salts exhibit low solubility. A survey of platinum salts shows that both Pt²⁺ and Pt⁴⁺ are sparingly soluble in water. Thus, a possible additive is NH₄I, which is highly soluble in water. With this in mind, the following approach is proposed, and leads to the following defining experiments, all conducted with platinum catalyst supported on carbon black.

Platinum catalyst, supported on carbon black, is placed in a test tube containing various strengths of NH₄I. The consistency is that of a paste. PtI₂ is essentially insoluble while PtI₄ has a very low solubility. Thus, in what follows we will assume that Pt salt, if formed, is PtI₄. The solubility product is given by
PtI₄(solid)→PtI₄(dissolved in water, saturated)→Pt⁴⁺+4I⁻(in solution)
The law of mass action product is given by
Kₛ₍₁₎=[Pt⁴⁺ [symbol] I⁻]⁴ (13)

Platinum ion concentration in the liquid is given by

$$[ {Pt}^{4 +} ] = \frac{{K}_{s ( 1 )}}{{[ {I}^{-} ]}^{4}} \qquad ( 14 )$$

If the only salt present in solution is PtI₄, the electroneutrality is └I⁻┘=4└Pt⁴⁺┘, which assumes negligible concentrations of other ions. This assumption need not be true in reality, and can be easily taken into account. Then,

$$\begin{matrix}[ {Pt}^{4 +} ] = \frac{1}{{2}^{8 / 5}} {K}_{s ( 1 )}^{1 / 5} & ( 15 ) \\ and & \\ ⌊ {I}^{-} ⌋ = {2}^{2 / 5} {K}_{s ( 1 )}^{1 / 5} & ( 16 )\end{matrix}$$

If NH₄I is added and its concentration is C, such that C>>2^{2/5}Kₛ₍₁₎^{1/5}, then the concentration of Pt⁴⁺ will be given by

$$[ {Pt}^{4 +} ] = \frac{{K}_{s ( 1 )}}{{C}^{4}} ⪡ \frac{1}{{2}^{8 / 5}} {K}_{s ( 1 )}^{1 / 5} \qquad ( 17 )$$

Thus, we expect NH₄I to suppress catalyst growth and catalyst degradation. There are many possible choices of additives which will suppress catalyst degradation using the above reasoning. For example, if finely divided silver is introduced in the presence of chloride ions, then at 300 K the reaction
4Ag+PtCl₄→Pt+4AgCl
is favored with standard free energy of −275.34 kJ/mol. Thus, the addition of finely divided silver powder can also lower the concentration of platinum ions. The general approach involves the introduction of those materials, which will tend to lower the concentration of platinum ions in solution.
Experimental Evidence:

In a typical PEMFC, significant catalyst degradation requires a few hundred hours. In PEMFC, no platinum salt is added intentionally. Whatever platinum salt may be present is formed in-situ. In order to determine the validity of the above particle growth mechanisms, it is expeditious to actually increase the degradation kinetics by deliberately introducing a platinum salt, so that effects can be observed in a shorter time frame than what would occur in reality. With this view in mind, the following experiment was conducted.

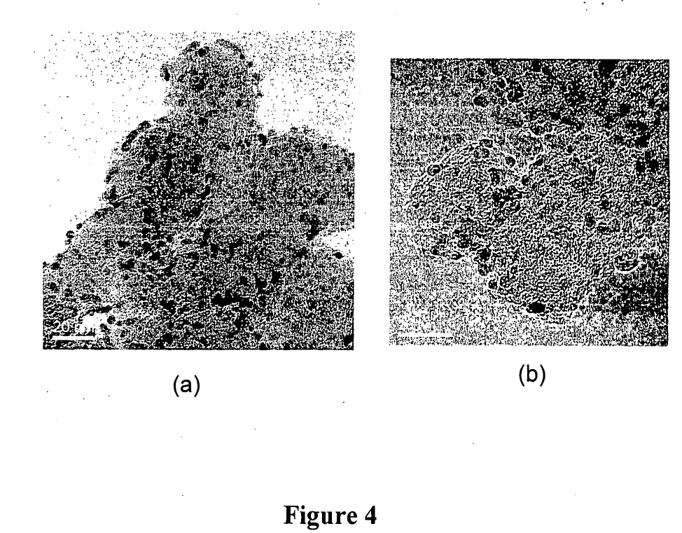

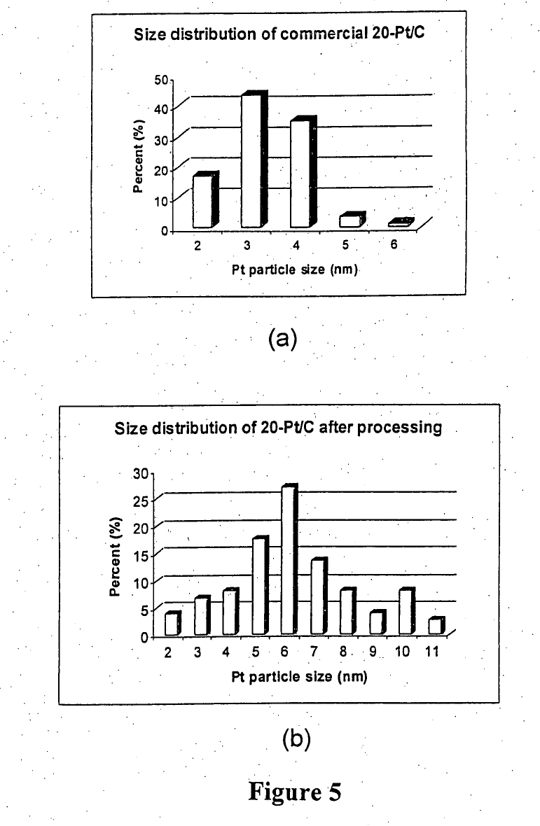

Preliminary experimental results which support the above-described model on the kinetics of Pt catalyst growth by coupled transport are described in what follows. For this experiment, Pt-catalyst supported on carbon was purchased from E-TEK (20% Pt—C). A paste of the sample was made on a glass slide by adding a dilute PtCl₄ solution in dilute HNO₃. The glass slide was covered to prevent evaporation. After 3 hours, the paste was washed to remove PtCl₄, and the sample was dried. XRD patterns were obtained before and after the treatment, which indicated particle growth. Subsequently, the samples were examined in TEM. FIG. 4(a) shows that in the as-received material from E-TEK, the Pt catalyst is well dispersed, and supported on carbon. The corresponding measured size distribution is shown FIG. 5(a). Note that the majority of the particles are in the 3 to 4 nm size ranges, with negligible number of particles at 5 nm and beyond. FIG. 4(b) is a TEM image of the sample after a mere 3 hour treatment in a dilute PtCl₄ solution. Note that significant particle growth has occurred, with particle size on the order of 4 to 5 nm. FIG. 5(b) shows the corresponding measured particle size distribution. Note that the majority of the particles are now in the range from 5 to 7 nm, with significant number of particles of size as large as 10 nm, and some even larger. The average particle size grew from about ˜3.5 nm to ˜6.5 nm. This represents a loss in catalyst surface area by ˜47% in just 3 hours. This shows the profound effect of Pt(+4) ion concentration and the presence of a contiguous electronic path provided by the carbon support. This experiment confirms the above scientific underpinning of the model, but more importantly, reveals approaches which allow the suppression of catalyst growth in accordance with the present invention. Such approaches can substantially increase opportunities for commercial exploitation of the PEMFC technology.

In a typical PEMFC, the time required for particles to grow from ˜3.5 nm to ˜6.5 nm will be likely be a few hundred hours, instead of 3 hours in the present experiments. Significant increase in growth rate was achieved by deliberately introducing a platinum salt (PtCl₄). The present invention shows that if one adds a salt which suppresses platinum ion concentration, such as NH₄I, the platinum ion concentration will be suppressed. Therefore, by adding a platinum ion suppressing additive to a platinum catalyst containing PEMFC, the time over which catalyst growth will occur may be extended to a few thousand hours. Effectively, this should lead to stabilization of the catalyst and thus of the PEMFC. This extended period will also allow for easier and more effective commercialization of PEMFC fuel cells, particularly when used in automobiles.

Although the examples set forth above are specific to platinum catalysts, the principle of the present invention can be applied with similar efficacy to PEMFCs containing other precious metal and precious metal alloy catalysts. Based on the above examples, one skilled in the art could readily identify and select appropriate additives for a broad spectrum of catalyst materials.

The additive components of the electrolyte solutions of the present invention can act to reduce or inhibit precious metal ion concentrations in two ways, or in other words the additives can be classified into two categories, equilibrium altering additives or competing additives. Equilibrium altering additives act by shifting the equilibrium of the electrolyte solution so as to effectively reduce the concentration of or inhibit the formation of precious metal ions in the electrolyte solution. Equilibrium altering additives typically include an anionic component, such as the chloride ion component set forth in the discussion above. Other non-limiting examples of equilibrium altering additives include, but are not limited to, chlorides, iodides, bromides, nitrates, sulfates, nitrites, sulfites, chlorates, as well as water soluble salts containing organic groups, or combinations thereof. Specific non-limiting examples of equilibrium altering additives can include NH₄I, NH₄Cl, NH₄Br, and combinations thereof.

Competing additives function to reduce the concentration of or inhibit the formation of precious metal ion concentration in the electrolyte solution by providing equilibrium reactions with more favorable standard free energies than the precious metal of the catalyst. Competing additives typically include or form a cationic component, such as the finely divided silver particles discussed above. Other competing additives can include any metal which is less noble or more reactive than the previous metal used in the catalyst, so long as the competing additive is not substantially reactive with water or other components of the fuel cell. In some cases it may be possible to use a precious metal as a competing additive so long as that precious metal is not present as the catalyst and is more reactive than the precious metal in the catalyst. The cationic component of the competing additive competes with the precious metal ions formed from the catalyst thereby reducing the precious metal ion concentration and suppressing formation of additional precious metal ions. Examples of competing additives include, but are not limited to, silver particles, copper particles, cobalt particles, nickel particles, and combinations thereof.

Equilibrium additives and competing additives can be used effectively alone or in combination to reduce the concentration of and/or inhibit the formation of catalyst precious metal ions, and thereby reduce or suppress catalyst degradation through Ostwald ripening. As a general guideline, the additive(s) can comprise from about 0.001 vol % to about 10 vol % of the electrolyte solution. However, volumes outside this range may also be suitable depending on the specific additive and catalyst system. The selection of the appropriate equilibrium altering additive can be influenced by the type the catalyst materials, namely the exact previous metal(s) found therein. In view of the disclosure of the present invention, one of ordinary skill in the art could readily optimize the relationships between particular precious metal catalysts and effective equilibrium altering additives.

It is understood by those skilled in the art that there are numerous possible salts or additives that may be introduced, which will be effective in decreasing platinum ion concentration in solution, and thereby suppress the catalyst growth kinetics. All such additives are covered by this invention.

What is claimed is:

1. A fuel cell liquid electrolyte solution comprising:
a liquid medium; and
an additive
wherein when the fuel cell liquid electrolyte solution is added to a proton exchange membrane fuel cell, it lowers precious metal ion concentration and/or inhibits formation of precious metal ions, said precious metal ions corresponding to metals used as catalysts of the proton exchange membrane fuel cell.

2. The electrolyte solution of claim 1, wherein the additive is water soluble.

3. The electrolyte solution of claim 1, wherein the additive is an equilibrium altering additive.

4. The electrolyte solution of claim 3, wherein the equilibrium altering additive includes a chloride, an iodide, a bromide, a nitrate, a sulfate, a nitrite, a sulfite, a chlorate, water soluble salts containing organic groups, or combination thereof.

5. The electrolyte solution of claim 1, wherein the additive is free of the precious metal used as the catalyst of the proton exchange membrane fuel cell.

6. The electrolyte solution of claim 1, wherein the precious metal used as the catalyst of the proton exchange membrane fuel cell is platinum, palladium, rhodium, iridium, alloys thereof, or alloys thereof with other metals.

7. The electrolyte solution of claim 6, wherein the precious metal used as the catalyst of the proton exchange membrane fuel cell is platinum or alloys thereof.

8. The electrolyte solution of claim 6, wherein the additive is NH₄I, NH₄Cl, NH₄Br, finely divided silver particles, or mixtures thereof.

9. The electrolyte solution of claim 1, wherein the additive is a competing additive.

10. The electrolyte solution of claim 9, wherein the competing additive includes finely divided silver particles, copper particles, cobalt particles, nickel particles, or combinations thereof.

11. The electrolyte solution of claim 10, wherein the additive is finely divided silver particles.

12. The electrolyte solution of claim 1, wherein the additive comprises from about 0.001 vol % to about 10 vol % of the solution.

13. A method of suppressing catalyst degradation in proton exchange membrane fuel cells comprising:
providing an additive in an amount sufficient to reduce precious metal ion concentration in an electrolyte solution and/or inhibit formation of precious metal ions into an electrolyte solution from the catalyst of the proton exchange membrane fuel cell.

14. The method of claim 13, wherein the additive is water soluble.

15. The method of claim 13, wherein the additive is an equilibrium altering additive.

16. The method of claim 15, wherein the additive includes a chloride, an iodide, a bromide, a nitrate, a sulfate, a nitrite, a sulfite, a chlorate, water soluble salts containing organic groups, or combinations thereof.

17. The method of claim 13, wherein the additive is free of the precious metal used as the catalyst of the proton exchange membrane fuel cell.

18. The method of claim 13, wherein the precious metal from the catalyst of the proton exchange membrane fuel cell is platinum, palladium, rhodium, iridium, alloys thereof, or alloys thereof with other metals.

19. The method of claim 18, wherein the additive is NH₄I, NH₄Cl, NH₄Br, finely divided silver particles, or mixtures thereof.

20. The method of claim 13, wherein the additive is a competing additive.

21. The method of claim 20, wherein the additive includes finely divided silver particles, copper particles, cobalt particles, nickel particles, or combinations thereof.

22. The method of claim 13, wherein the additive comprises from about 0.001 vol % to about 10 vol %.

23. A fuel cell, comprising
a proton exchange membrane impregnated with the electrolyte solution of claim 1,
an anode; and
a cathode,
wherein the anode and the cathode are operatively associated with the proton exchange membrane.
